(19) United States
(12) Patent Application Publication
(10) Pub. No.: US 2009/0302113 A1
(43) Pub. Date: Dec. 10, 2009

(54) LICENSE CHECKER

(75) Inventors: Chien-Shu Li, Taipei City (TW); Ku-Fang Wang, Taipei City (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei City (TW)

(21) Appl. No.: 12/136,061

(22) Filed: Jun. 10, 2008

(51) Int. Cl. G06K 7/10

(52) U.S. Cl. 235/454

(57) ABSTRACT

A license checker for use in a vending machine for controlled hazardous items is disclosed to include a housing, which has an insertion slot and a card space defined in a rack thereof in communication with the insertion slot, a sensor module, which comprises photo sensors for detection the insertion of a license into the housing and elastic return devices movable relative to the photo sensors subject to insertion of a license for causing the photo sensors to output a driving signal, a light source module, which is driven by the driving signal from the photo sensors to emit various wavelengths of light onto the anti-counterfeit characteristics and character data of the license in a predetermined order, and an image pickup module, which picks up the image of anti-counterfeit characteristics and character data of the license for license authenticity validation and character data recognition.

### BACKGROUND OF THE INVENTION

1. Field of the Invention

The present invention relates to a license checking device and more particularly, to a license checker that utilizes a light source to emit various wavelengths of light in a predetermined order for enabling an image pickup module to pickup the image of the anti-counterfeit characteristics and character data of the inserted license for comparison with a reference data and recognition through an optical character recognition (OCR) procedure so that the authenticity of the license and the age of the license holder of the inserted license are checked.

2. Description of the Related Art

Following fast development of technology, our mode of living has been changed, and different automatic vending machines are used everywhere to sell different products without serviceman. These automatic vending machines are highly invited for the advantage of saving much labor and bringing convenience to people. For example, a Q-shop has the advantages of scientific intelligence, quick service and quick finish of payment. A Q-shop may provide automatic vending machines for vending drinks, cigarettes, tickets, ice creams, memorial coins, key rings, or even hamburgers and noodles. Nowadays, many virtual shops are established to make online shopping, allowing shoppers to shop across millions of products.

However, regular vending machines do not limit sales to any person of any age. Therefore, regular vending machines commonly sell popular goods such as fruit juice beverages, carbonated beverages, food, etc. These vending machines cannot sell age-controlled merchandises such as cigarettes or alcohol drinks, or other controlled merchandises such as drugs, strong acids/alkalines detergent, or other hazardous items. To prohibit young children from buying age-controlled merchandises or unqualified people from buying controlled items, a vending machine for vending age-controlled or controlled merchandises must be equipped with a security system to recognize the age or identification of the consumer.

Following development of technology and establishment of license systems, people may need to obtain different licenses for different qualifications. One person may carry many different licenses. However, regular licenses can easily be copied. In order to prevent counterfeit, anti-counterfeit techniques are developed and applied to issue of licenses. There is known a license authenticity checking device for automatic vending machine that verifies the authenticity of a license by means of radiating the license with two or more different wavelength lights and then checking the variation of amplitude thus produced for further comparison with anti-counterfeit reference data.

Therefore, designing an automatic vending machine for vending age-controlled or specifically controlled merchandises must consider the recognition of the traders' real age or identity. The trader must insert a personal identification card (such as driver license, ID card, IC card, etc.) into the machine for checking the real age and/or identity. The automatic vending machine allows the transaction only when the trader's identify is verified and the trader's is checked over the legal age, for example, 18 years old. However, the problem of counterfeit licenses must be taken into account and prevented. Following fast development of computer technology, evil persons may use computer scanning, copying and printing technology to make counterfeit licenses for cheating money or goods from venders. Therefore, an automatic vending machine for vending age-controlled or specifically controlled merchandises must be equipped with a high-performance license checker to verify different characteristics (water mark, paper quality, personal data, etc.), assuring safety.

However, designing an automatic vending machine for controlled items must take the following considerations into account:

An automatic vending machine for vending age-controlled items must be capable of checking the identity and age of the trader, avoiding sales of controlled items (tobacco or liquor) to young persons or children. For vending controlled hazardous items, an automatic vending machine must recognize the identity of the trader and record the related data for tracing.

Following fast development of computer technology, evil persons may use computer scanning, copying and printing technology to make counterfeit licenses for cheating money or goods from venders. Therefore, an automatic vending machine must be capable of checking different anti-counterfeit characteristics of a license, preventing cheating by a counterfeit license.

Therefore, it is desirable to provide a license checker for automatic vending machine that validates the authenticity of the inserted license and recognizes the identity and age of the license holder of the inserted license.

### SUMMARY OF THE INVENTION

The present invention has been accomplished under the circumstances in view. It is therefore one object of the present invention to provide a license checker, which validates the authenticity of the inserted license and simultaneously recognizes the identity and age of the license holder of the inserted license. To achieve this and other objects of the present invention, the license checker comprises a housing, a sensor module, a light source module, and an image pickup module. The housing defines an insertion slot and a card space for receiving a license for checking. The sensor module is mounted in the housing, comprising a plurality of elastic return devices and a plurality of photo sensors respectively adjacent to the elastic return devices. The elastic return devices are forced to occlude the photo sensors upon insertion of a license through the insertion slot into the card space. The light source module is mounted inside the housing, comprising a plurality of light emitting devices that are controllable to emit various wavelengths of light toward the card space. The image pickup module comprises an image pickup lens aimed at the card space for picking up the image of anti-counterfeit characteristics and character data of an inserted license. When a license is inserted through the insertion slot into the card space and set in position, the elastic return devices are forced to occlude the photo sensors, and the light emitting devices of the light source module are driven to emit various wavelengths of light onto the license in a predetermined order for enabling the image pick up module to pick up the image of anti-counterfeit characteristics and character data of the license through an optical character recognition (OCR) technique for license authenticity validation and character data recognition.

When the license checker is used in an automatic vending machine for vending controlled items or hazardous items, the license checker validates the authenticity of an inserted license and recognizes the identity and age of the license holder of the license.

Further, the invention can also be used in an automatic vending machine for vending medicines so that any person suffering chronic diseases can purchase particular medicines from the automatic vending machine directly and needs not to go to a hospital for getting the same medicines.

Further, the license checker also records the birthday date, photo, license number, transaction time and other transaction-related data for further review. The recorded data can also be used to help policemen investigate or trace criminals.

### BRIEF DESCRIPTION OF THE DRAWINGS

FIG. 1 is an elevational view of a license checker in accordance with the present invention.

FIG. 2 is an exploded view of the license checker in accordance with the present invention.

FIG. 3 is a schematic side view of the present invention, showing a status of use of the license checker (I).

FIG. 4 is a schematic side view of the present invention, showing a status of use of the license checker (II).

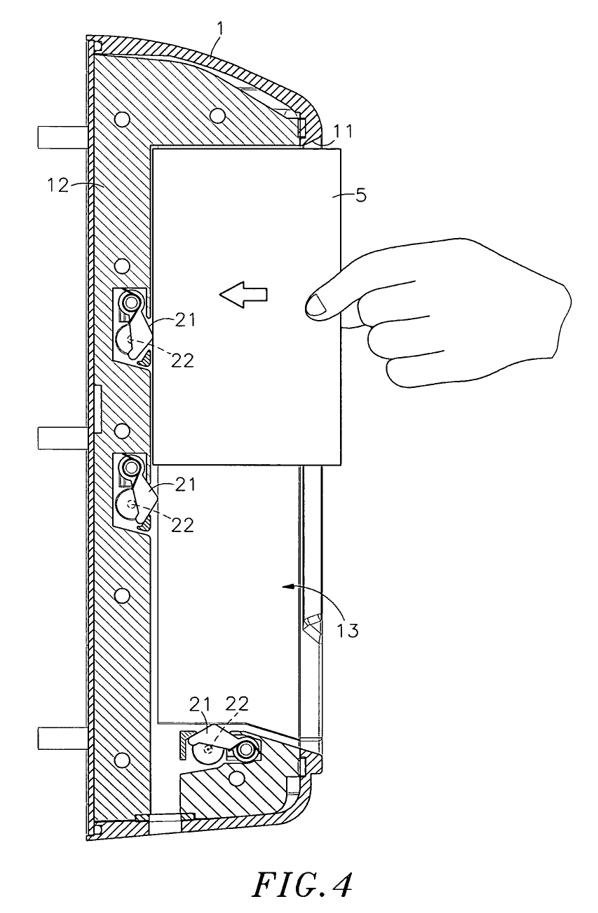

FIG. 5 is a schematic side view of the present invention, showing a status of use of the license checker (III).

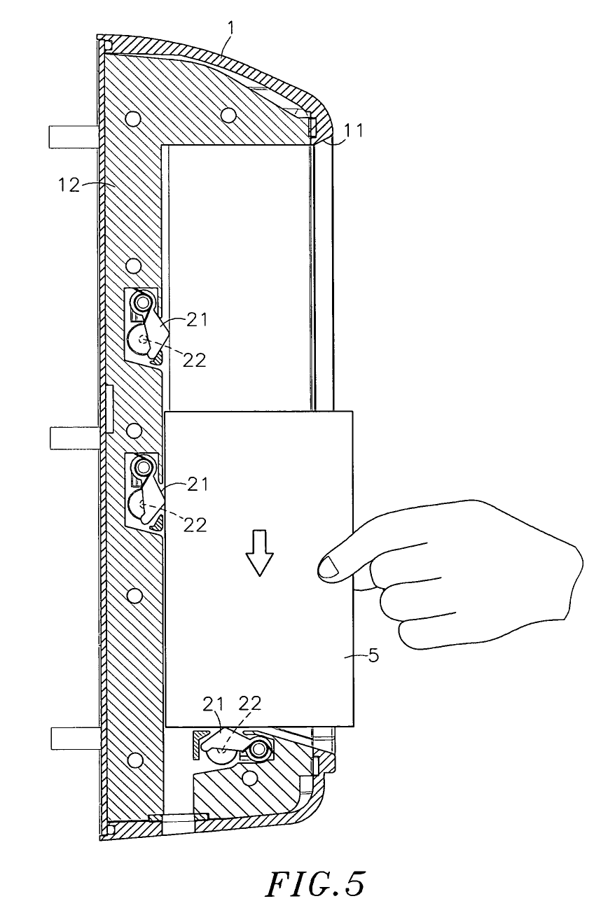

FIG. 6 is a schematic sectional side view of the present invention, showing the image pickup module of the license checker in action.

FIG. 7 is an operation flow chart of the license authenticity validating procedure of the license checker according to the present invention.

FIG. 8 is an operation flow chart of the character recognition procedure of the license checker according to the present invention.

### DETAILED DESCRIPTION OF THE PREFERRED EMBODIMENT

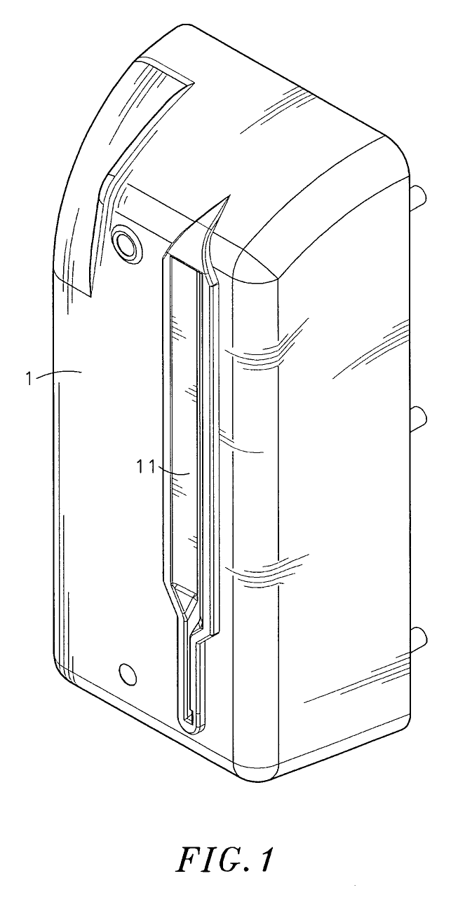

Referring to FIGS. 1˜5, a license checker in accordance with the present invention is shown comprising a housing 1, a sensor module 2, a light source module 3 and a image pickup module 4. The housing 1 houses the sensor module 2, the light source module 3 and the image pickup module 4.

The housing 1 comprises an insertion slot 11 for the insertion of a license, a rack 12 fixedly mounted therein, a card space 13 defined in the rack 12 in communication with the insertion slot 11, and a transparent dust cover 14 disposed at one lateral side relative to the card space 13.

The sensor module 2 is mounted in the rack 12 around the card space 13, comprising a plurality of elastic return devices 21 and photo sensors 22 respectively arranged at two sides relative to the elastic return devices 21.

The light source module 3 is mounted in the rack 12 at one lateral side, comprising a plurality of light emitting devices 31 controllable to emit various wavelengths of light toward the card space 13. The light emitting devices 31 can be infrared, ultraviolet, white LEDs or other LEDs with various wavelengths.

The image pickup module 4 is disposed adjacent to the light source module 3, having an image pickup lens 41 aimed at the card space 13 opposite to the transparent dust cover 14.

When in use, the license checker is installed in an automatic vending machine for checking the authenticity of a license 5 (passport, driver license, ID card or health insurance card). When a user inserted a license 5 through the insertion slot 11 into the card space 13, the elastic return devices 21 are forced by the inserted license 5 to occlude the photo sensors 22, thereby causing the photo sensors 22 to output a signal, and therefore the light emitting devices 31 are driven to emit various wavelengths of infrared light or visible light onto the license 5 and the image pickup lens 41 of the image pickup module 4 is driven to pick up images from the license 5.

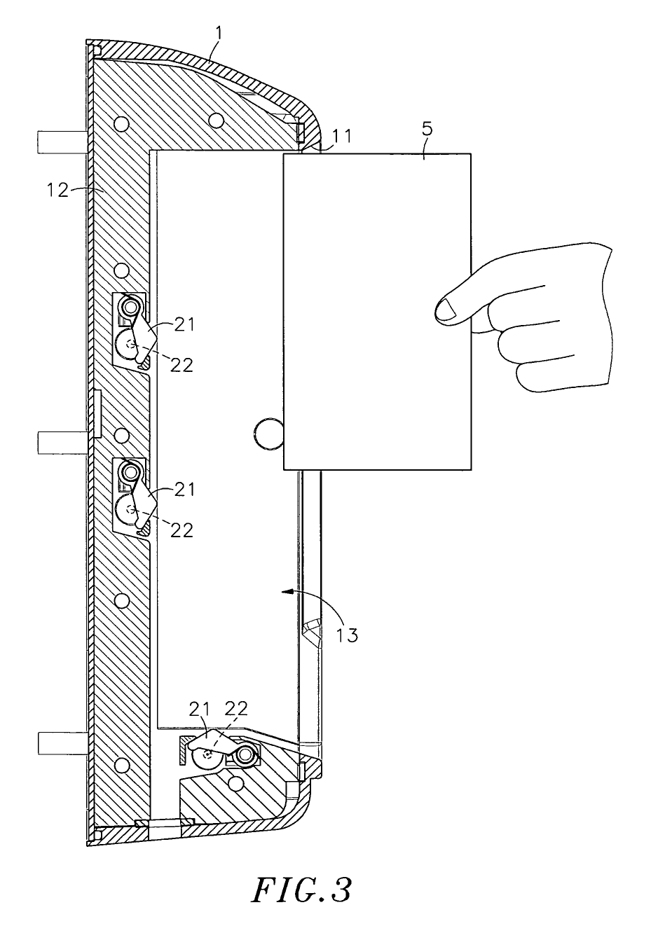

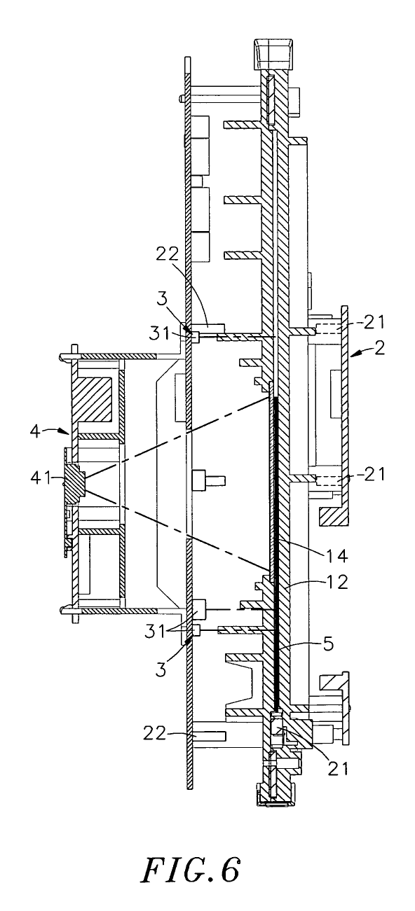

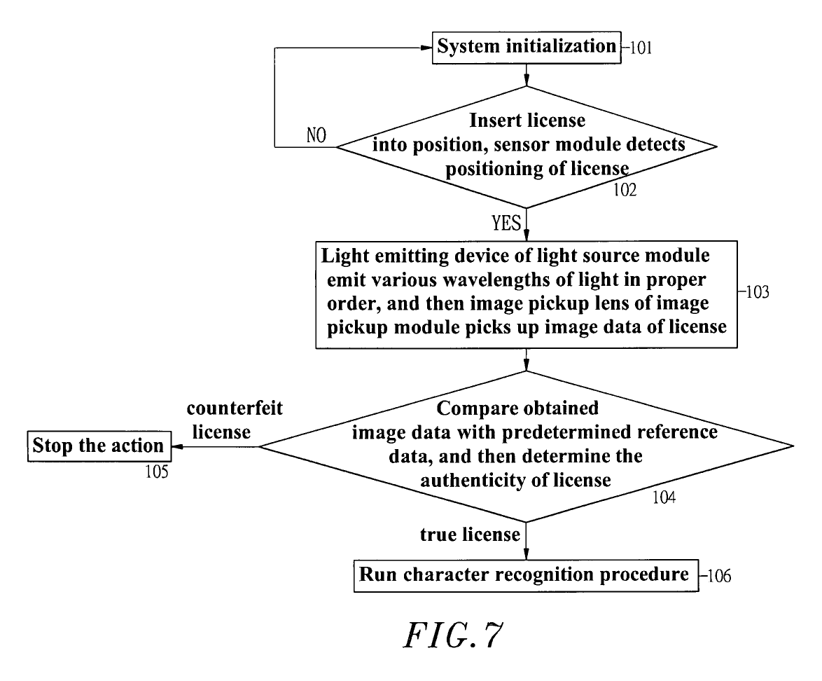

Referring to FIGS. 6 and 7 and FIG. 3 again, when a license 5 is inserted through the insertion slot 11 into the card space 13, the license checker works subject to the following steps:
101 System initialization.
102 The sensor module 2 judges whether or not a license 5 is inserted into position? And then the system proceeds to step 103 if yes, or returns to step 101 if not.
103 The light emitting devices 31 of the light source module 3 are controlled to emit light in proper order, and the image pickup lens 41 of the image pickup module 4 is driven to pick up image data from the license 5.
104 The system compares the fetched image data with a reference data obtained from the image database and then judges the authenticity of the license 5, and then proceeds to step 105 when the license 5 is judged to be a counterfeit, or step 106 if the license 5 is a true license.
105 The system stops all actions.
106 The system runs a character recognition procedure.

According to the present invention, when one light emitting device 31 emits infrared light onto the surface of the inserted license 5, the ink of the license 5 gives a reflection. At this time, the image pickup module 4 picks up the image of the license 5 from the reflected light through the image pickup lens 41 and then converts the image into an image data. Thereafter, the system turns off the infrared light emitting device and then drives light source module 3 to emit ultraviolet light onto the license 5 so that the image pickup module 4 can pickup the image data of the fluorescent fiber of the license 5. Therefore, the system compares image data of the ink and fluorescent fiber with related reference data stored in the database, and then judges the authenticity of the license 5 subject to the comparison result.

The aforesaid image pickup lens 41 can be a CCD (charge coupled device), CMOS (complementary metal oxide semiconductor), CIS (contact image sensor) or any digital image pickup lens. Except the aforesaid infrared and ultraviolet light, the image pickup module 4 can be used with other various wavelengths of light for validating the authenticity of a license 5.

By means of the application of the aforesaid infrared and ultraviolet light to radiate the anti-counterfeit characteristics (watermark, steel stamp, hidden barcode, laser mark, etc.) of the license 5, the image pickup module 4 obtains the image data of the anti-counterfeit characteristics of the license 5 for validating the authenticity of the license 5. If the license 5 is validated to be a counterfeit, the system immediately gives a corresponding signal to the automatic vending machine, causing the automatic vending machine to stop the transaction. If the license 5 is validated to be a true license, the system immediately runs a character recognition procedure.

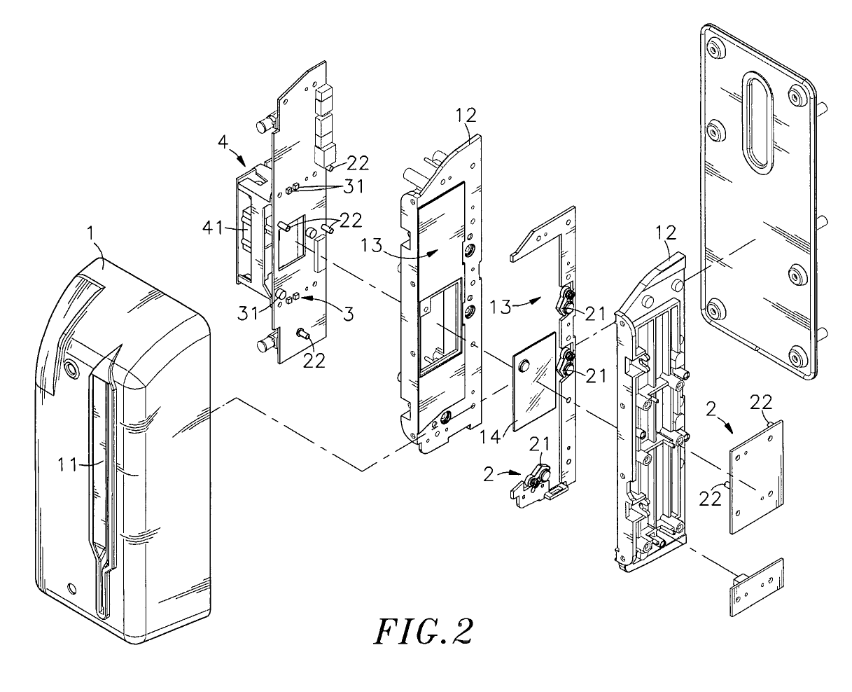

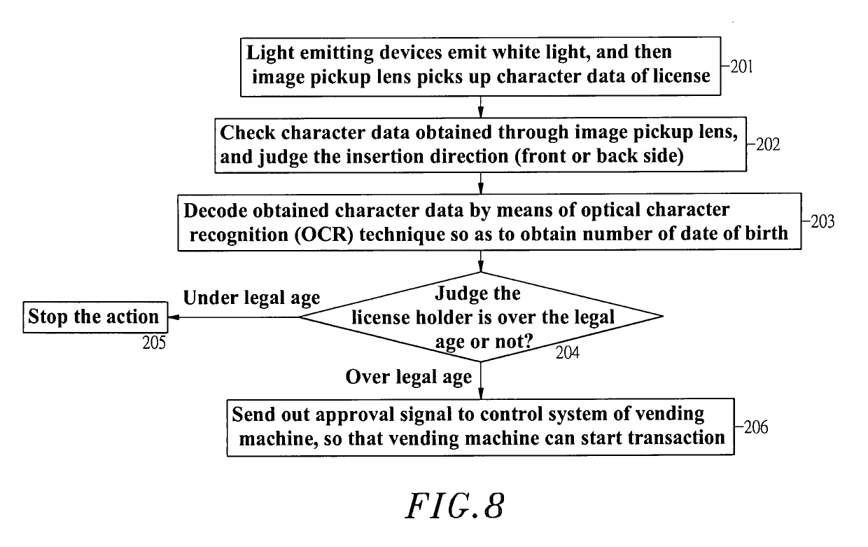

Referring to FIG. 8 and FIGS. 2 and 6 again, when the license 5 is validated to be a true license, the license checker immediately runs the character recognition procedure to recognize the birthday data of the license 5 subject to the following steps:
201 At first, the light emitting devices 31 emit white light onto the license 5, and then the image pickup lens 41 picks up the image of the character data from the license 5.
202 The license checker (control circuit of the license checker) checks the character data obtained through the image pickup lens 41 and judges the insertion direction (front or back side).
203 The license checker (control circuit of the license checker) decodes the obtained character data by means of an OCR (optical character recognition (OCR)) technique, thereby obtaining the number of the date of birth of the license holder.
204 The license checker (control circuit of the license checker) judges whether or not the license holder is over the legal age? And then the system (control circuit of the license checker) proceeds to step 206 when the license holder is over the legal age, or step 205 when not.
205 The license checker (control circuit of the license checker) stops the operation.
206 The license checker (control circuit of the license checker) outputs an approval signal to the control system of the automatic vending machine, for enabling the automatic vending machine to start the transaction.

Therefore, after validation of the license 5, the image pickup module 4 starts to recognize the data zone of the birth day data of the license 5 and at the same time, the light emitting devices 31 are controlled to emit white light onto the data zone of the birth day data of the license 5 for enabling the image pickup lens 41 of the image pickup module 4 to pick up the image of the birth date data from the license 5 positively for accurate recognition through an optical character recognition (OCR) technique. The birthday data thus obtained is compared to the current time, thereby determining whether the age of the license holder is below or over the legal age. Thereafter, the license checker sends the recognition result to the automatic vending machine so that the automatic vending machine can start or stop the transaction subject to the comparison result signal from the license checker.

The aforesaid recognition procedure simply recognizes the birthday data of the license holder. However, this recognition procedure is simple an example of the present invention but not a limitation. For example, the license checker can be designed to recognize and record the data of the name, birthday and ID number of the customer as well as the transaction item of each transaction. In case the vending machine is adapted for vending controlled hazardous items, the recorded data is useful for further data filing and search.

Further, when either of the license authenticity check, legal age check and license holder identity check does not match, the license checker will immediately end the transaction, and all the related data of the transaction, either successful or unsuccessful, will be recorded further filing or search.

Further, the light emitting devices 31 of the light source module 3 are controlled or designed to emit visible light such as blue light or green light, or invisible light such as ultraviolet light subject to the nature of the anti-counterfeit characteristics and data zone of the license 5 to be radiated, thereby facilitating image pickup and recognition of the image pickup module 4.

In conclusion, the license checker of the present invention has the following features and advantages.

The invention utilizes the image pickup module 4 for validating the authenticity of the license 5 and recognizing the data of age and identity of the license holder. By means of controlling the light source module 3 to emit various wavelengths of light onto various anti-counterfeit characteristics of the license 5, the image pickup module 4 positively picks up the image data of the anti-counterfeit characteristics of the license 5 for authenticity validation. After recognition of the authenticity of the license 5, the birthday data of the license 5 is recognized by means of an optical character recognition (OCR) technique, and therefore the license checker can determine whether or not the license holder is over the legal age and control the automatic vending machine to start or stop the transaction subject to recognition result, avoiding vending of tobacco, liquor or other controlled hazardous items to young people or children and preventing a violation of local laws. Further, when the license checker is used in an automatic vending machine for vending medicines or other controlled hazardous items, the license checker can record the data of the name, birthday and ID number of the license holder (customer) as well as the transaction item and time of each transaction for further filing and search. Therefore, the invention protects automatic vending machine providers or sellers from other people's threatening or damage due to direct selling of controlled items. The invention can also be used in an automatic vending machine for vending medicines so that any person suffering chronic diseases can purchase particular medicines from the automatic vending machine directly and needs not to go to a hospital for getting the same medicines. Further, an automatic vending machine using the present invention can record the birthday date, photo, license number, transaction time and other transaction-related data for further review. The recorded data can also be used to help policemen investigate or trace criminals.

As stated above, the main feature of the present invention is the use of the light source module 3 that emits various wavelengths of light onto various anti-counterfeit characteristics and character zones of the license 5 to be checked so that the image pickup module 4 positively picks up the image of the anti-counterfeit characteristics and character data of the license 5 for checking the authenticity of the license 5 and the identity and age of the license holder of the license 5. Therefore, an automatic vending machine equipped with a license checker of the present invention can sell controlled or hazardous items. The license checker of the present invention can also record transaction-related data of each transaction for further filing and search. Further, the license checker of the present invention can also be used in a coin exchange machine, automatic teller machine, card dispenser device or the like.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A license checker comprising:
a housing, said housing comprising an insertion slot through which a license is inserted into said housing for checking, a rack fixedly mounted therein, and a card space defined in said rack and disposed in communication with said insertion slot;
a sensor module mounted in said rack around said card space, said sensor module comprising a plurality of elastic return devices and a plurality of photo sensors respectively adjacent to said elastic return devices, said elastic return devices being forced to occlude said photo sensors upon insertion of a license through said insertion slot into said card space;
a light source module mounted in said rack at one lateral side, said light source comprising a plurality of light emitting devices controllable to emit various wavelengths of light toward said card space; and
an image pickup module disposed adjacent to said light source module, said image pickup module comprising an image pickup lens aimed at said card space for picking up the image of anti-counterfeit characteristics and character data of a license being inserted through said insertion slot into said card space;
wherein a license is inserted through said insertion slot into said card space, said elastic return devices are forced to occlude said photo sensors, and said light emitting devices of said light source module are driven to emit various wavelengths of light onto the license in a predetermined order for enabling said image pick up module to pick up the image of anti-counterfeit characteristics and character data of the license for license authenticity validation and character data recognition.

2. The license checker as claimed in claim 1, wherein said housing comprises a transparent dust cover mounted in said rack and disposed at one lateral side of said card space.

3. The license checker as claimed in claim 1, wherein said light emitting devices of said light source module are light emitting diodes capable of emitting infrared, ultraviolet and white light.

4. The license checker as claimed in claim 1, wherein said image pickup lens is a charge coupled device.

5. The license checker as claimed in claim 1, wherein said image pickup lens is a complementary metal-oxide semiconductor.

6. The license checker as claimed in claim 1, wherein said image pickup lens is a contact image sensor.
